(19) United States
(12) Patent Application Publication
(10) Pub. No.: US 2014/0358569 A1
(43) Pub. Date: Dec. 4, 2014

(54) DISCOVERY OF CONTAMINATED PRODUCTS

(71) Applicant: Michael T. Lucas, Solona Beach, CA (US)

(72) Inventor: Michael T. Lucas, Solona Beach, CA (US)

(21) Appl. No.: 13/909,121

(22) Filed: Jun. 4, 2013

(51) Int. Cl. G06Q 30/00; G06Q 50/22

(52) U.S. Cl. CPC G06Q 30/018; G06Q 50/22
USPC 705/2

(57) ABSTRACT

Systems and methods, including computer program products, for facilitating and expediting discovery of contaminated products. Second personal identifiers associated with a first personal identifier are looked up. A list of merchant identifiers and transaction identifiers associated with the second personal identifiers are retrieved. From the merchant transaction database, a list of product identifiers associated with the second consumer identifiers is extracted. The list of product identifiers is compared to a potentially contaminated product list and the potentially contaminated product list is updated with product identifiers common to both the list of product identifiers and the potential contaminated product list. The number of product identifiers in the updated potentially contaminated product list is compared with a threshold and a product testing recommended message is issued for product identifiers in the updated potentially contaminated product list in response to determining the number is below the threshold.

### BACKGROUND

In the United States alone, 31 of the known major food borne pathogens cause up to 9.4 million cases of food borne illness each year. With the large number of food products available to consumers from a wide variety of sources, determining the source of a food borne illness outbreak can be difficult and require an extended period of time. During the period of time required to establish the illness source, many other consumers may be unnecessarily exposed to the pathogen.

The field of epidemiology is responsible for exploring patterns, causes, and effects of health and disease conditions and for providing solutions for outbreak investigation, control and containment. The Centers for Disease Control and Prevention has defined a list of ten steps performed by epidemiologists to facilitate optimization of the speed and accuracy of outbreak investigations.

Investigators should prepare for fieldwork. To establish the existence of an outbreak, investigators determine that more than a normal number of cases of a disease occur within a given place or group. Investigators verify diagnosis by review of clinical findings and lab tests. Cases are defined and identified according to information about the disease, characteristics of the patients, information about the location and a particular duration. Compilation of a comprehensive description of outbreak trends over time will enable investigators to understand more about the outbreak. Investigators develop hypotheses as to the source of the disease, mode of transmission and/or exposures possible causing the disease. Facts are studied or numbers are processed to reveal actual statistics and evaluate the hypothesis. Investigators refine hypotheses and carry out additional studies including lab and environmental tests. Control and prevention measures are implemented to eliminate the disease source as well as interrupt transmission and limit exposure. With the cause identified and the control and prevention measures in place, investigation findings can be communicated to health authorities for possible further dissemination to the public.

While these steps provide a high-level organization for outbreak investigation, many of these steps require time to perform and during this time, a greater portion of a population may be exposed to the pathogen responsible for the outbreak. Thus reducing the time required for any of these steps will also reduce the degree of exposure of the population. With an outbreak established, development of a hypothesis and subsequent evaluation and refinement of that hypothesis should be handled quickly and effectively to enable appropriate control and prevention measures.

### SUMMARY

In accordance with one aspect of the invention, a computer-implemented method for discovering a contaminated product, includes looking up, within a merchant bank database, second personal identifiers associated with a first personal identifier in response to diagnosing a health condition in a patient identified by the first patient identifier in a patient healthcare database; retrieving a list of merchant identifiers associated with the second personal identifiers in the merchant bank database; retrieving a list of transaction identifiers associated with the second personal identifiers in a merchant transaction database associated with the merchant identifiers; extracting, from the merchant transaction database, a list of product identifiers associated with the second personal identifiers; comparing, to a potentially contaminated product list, the list of product identifiers; updating the potentially contaminated product list with product identifiers common to both the list of product identifiers and the potentially contaminated product list; measuring the number of product identifiers in the updated potentially contaminated product list against a threshold; issuing an inconclusive message in response to determining the number is above the threshold; and issuing a product testing recommended message for product identifiers in the updated potentially contaminated product list in response to determining the number is below the threshold.

In accordance with another aspect of the invention, a computer-implemented method for discovering a contaminated product includes looking up, within a merchant bank database, second personal identifiers associated with by a first personal identifier in a healthcare database in response to diagnosing a health condition in a first patient identified; retrieving a list of merchant identifiers associated with the second personal identifiers in the merchant bank database; extracting, from a merchant transaction database associated with the merchant identifiers, a first list of product identifiers associated with the second personal identifiers; in response to diagnosing a health condition in a second patient identified by a second patient first personal identifier in the healthcare database, looking up, within a merchant bank database, second patient second personal identifiers associated with the second patient second personal identifiers; retrieving a list of merchant identifiers associated with the second patient second personal identifiers in the merchant bank database; extracting, from a merchant transaction database associated with the merchant identifiers, a second list of product identifiers associated with the second patient second personal identifiers; recording product identifiers common to both the first list of product identifiers and the second list of product identifiers; comparing the number of product identifiers recorded with a threshold; issuing an inconclusive results message in response to determining the number is above the threshold; and issuing a product testing recommended message for the products associated with the product identifiers common to both the first list of product identifiers and the second list of product identifiers in response to determining the number is below the threshold.

In accordance with yet another aspect of the invention, a computer-implemented method includes associating a plurality of product identifiers with a plurality of consumer identifiers within a database of purchased contamination-vulnerable products during consumer transactions of a contamination-vulnerable product; retrieving, from a patient health database, a patient identifier of a first patient in response to determining that the first patient has a health condition potentially caused by a contamination-vulnerable product; matching the patient identifier to a first one of the plurality of consumer identifiers; storing product identifiers associated with the first of the plurality of consumer identifiers in a potentially contaminated products database; in response to determining that an additional patient has the illness potentially caused by a contamination-vulnerable product, retrieving, from the patient health database, a patient identifier of the additional consumer; matching the patient identifier of the additional consumer to a second of the plurality of consumer identifiers; retrieving product identifiers associated with the second of the plurality of consumer identifiers; updating the potentially contaminated products database with product identifiers associated with both the first and the second of the plurality of consumer identifiers; comparing the number of product identifiers in the updated potentially contaminated product list with a threshold; issuing an inconclusive results message in response to determining the number is above the threshold; and issuing a product testing recommended message for the products associated with the product identifiers in the updated potential contaminated product list in response to determining the number is below the threshold.

In accordance with one aspect of the invention, a system for discovering a contaminated product includes a consumer health database containing a plurality of consumer health record objects each including a first personal identifier; a first search engine configured to retrieve, from a merchant bank database, one or more second personal identifiers associated with the first personal identifier; a second search engine configured to retrieve, from the merchant bank database, a list of one or more merchant identifiers associated with the one or more second personal identifiers; a third search engine configured to extract, from a merchant transaction database associated with the merchant identifiers, a list of product identifiers associated with the one or more second personal identifiers; a first comparison engine configured to match, product identifiers from the list of product identifiers to potentially contaminated product identifiers in a potentially contaminated product list; a potentially contaminated product list update engine configured to update the potentially contaminated product list with product identifiers common to both the list of product identifiers and the potentially contaminated product list; a second comparison engine configured to compare the number of product identifiers in the updated potentially contaminated product list with a threshold; and an output engine configured to issue an inconclusive results message in response to determining the number is above the threshold and to issue a product testing recommended message for product identifiers in the updated potentially contaminated product list in response to determining the number is below the threshold.

In accordance with one aspect of the invention, a computer program product, stored on a non-transitory machine-readable medium, for discovering a contaminated product, includes instructions operable to cause a computer to retrieve, from a merchant bank database, one or more second personal identifiers associated with a first personal identifier stored in a consumer health database containing a plurality of patient health records; retrieve, from the merchant bank database, a list of one or more merchant identifiers associated with the one or more second personal identifiers; extract, from a merchant transaction database associated with the merchant identifiers, a list of product identifiers associated with the one or more second personal identifiers; match product identifiers from the list of product identifiers to potentially contaminated product identifiers in a potentially contaminated product list; update the potentially contaminated product list with product identifiers common to both the list of product identifiers and the potentially contaminated product list; compare the number of product identifiers in the updated potentially contaminated product list against a threshold; output an inconclusive results message in response to determining the number is above the threshold; and output a product testing recommended message for product identifiers in the updated potentially contaminated product list in response to determining the number is below the threshold.

### BRIEF DESCRIPTION OF THE DRAWINGS

FIG. 1 illustrates a first portion of a first example contaminated product discovery method, in accordance with an embodiment of the invention.

FIG. 2 illustrates a second portion of the first example contaminated product discovery method, in accordance with an embodiment of the invention.

FIG. 3 illustrates a third portion of the first example contaminated product discovery method, in accordance with an embodiment of the invention.

FIG. 4 illustrates a first portion of a second example contaminated product discovery method, in accordance with an embodiment of the invention.

FIG. 5 illustrates a second portion of the second example contaminated product discovery method, in accordance with an embodiment of the invention.

FIG. 6 illustrates a third portion of the second example contaminated product discovery method, in accordance with an embodiment of the invention.

FIG. 7 illustrates a fourth portion of the second example contaminated product discovery method, in accordance with an embodiment of the invention.

FIG. 8 illustrates a first portion of a third example contaminated product discovery method, in accordance with an embodiment of the invention.

FIG. 9 illustrates a second portion of the third example contaminated product discovery method, in accordance with an embodiment of the invention.

FIG. 10 illustrates a third portion of the third example contaminated product discovery method, in accordance with an embodiment of the invention.

FIG. 11 illustrates an example contaminated food product discovery system configured to support the first, second or third example contaminated product discovery methods, in accordance with an embodiment of the invention.

### DETAILED DESCRIPTION

During an outbreak, methods, systems and products in accordance with embodiments of the invention expedite development of a hypothesis and subsequent evaluation and refinement of that hypothesis to enable appropriate control and prevention measures and reduce unnecessary exposure to other members of a population. By linking a patient identifier to a product identifier, products purchased by diagnosed patients can be rapidly compared to identify commonly-purchased products and thereby enable quick hypothesis development and refinement. With the number of possibly contaminated products dramatically reduced, lab tests may be performed to verify the hypothesis.

A method, steps of which may be implemented by computer, enables rapid discovery of a contaminated product that is a potential source of a consumer health condition or illness.

In the present disclosure, the phrase “first personal identifier” may be any identifier enabling unique identification of a particular party and encompasses but is not limited to a patient number or a government issued identifier such as a social security number.

In the present disclosure, the phrase “second personal identifier” may be any identifier enabling unique identification of a particular party and encompasses but is not limited to a payment means identifier such as a credit card number, a debit card number or a consumer rewards program identifier.

In the present disclosure, the phrase “merchant bank database” encompasses but is not limited to a database including associations at least between first personal identifiers and second personal identifiers used during the completion of one or more transactions and thus the “merchant bank database” may store associations between, for example, social security numbers and credit card numbers.

In the present disclosure, the phrase “merchant database” encompasses but is not limited to a database including associations at least between an identifier uniquely identifying a transaction and identifiers uniquely identifying products purchased during the uniquely identified transaction.

In the present disclosure, a “product” can be any article capable of exchange between a merchant and a consumer or patient at a point of sale and may also include some types of services that may be performed by a provider to a consumer or patient. Products include, but are not limited to foods, beverages or other liquids, medications, surgical and other medical equipment, prostheses, dental devices and implants, pet supplies and clothing. It is noted that this list is not exhaustive and many other items may also be encompassed by the term “product”, for example, vehicles, plants, buildings, electronics and computer programs.

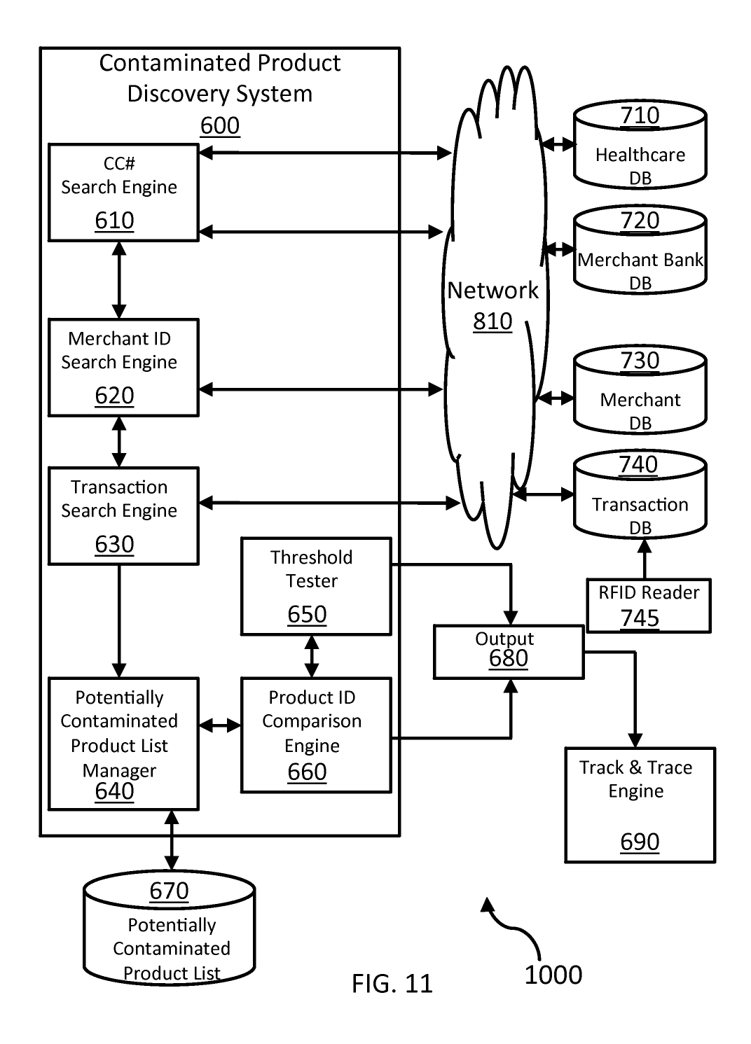

A healthcare database 710 (FIG. 11) containing data selectively accessible to physicians, physicians assistants, nurses and other employees of a healthcare provider who have valid authorizing credentials, such as passwords or passcodes, can include a number of files or data objects each comprising information pertaining to a patient or consumer who has been registered within the healthcare database. Each patient healthcare file may be identifiable by a first personal identifier and may include a variety of information about the patient including residential address, contact information, information about past, present and future appointments the patient had, is having or will have with the healthcare provider as well as, in some cases, family health history, geneology, housemates or roommates, etc.

To avoid privacy violations, access to information within patient healthcare files is only granted in accordance with local, state and federal laws, rules, regulations and policies and, in some embodiments, is only granted upon the approval of the patient represented by the healthcare file either at the time of establishing the existence of an outbreak or at another time.

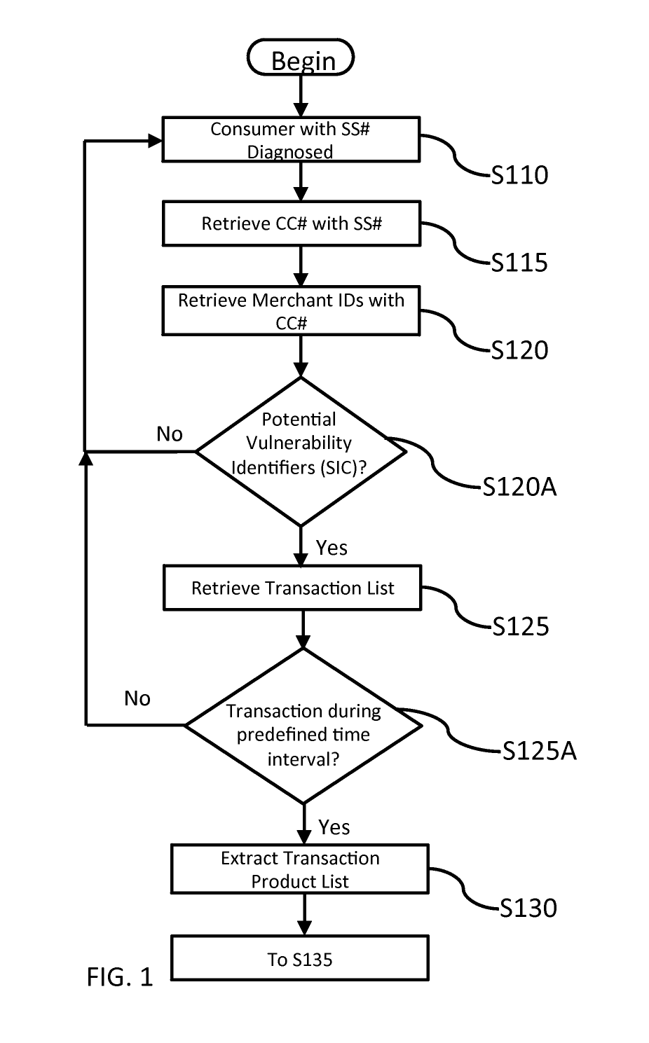

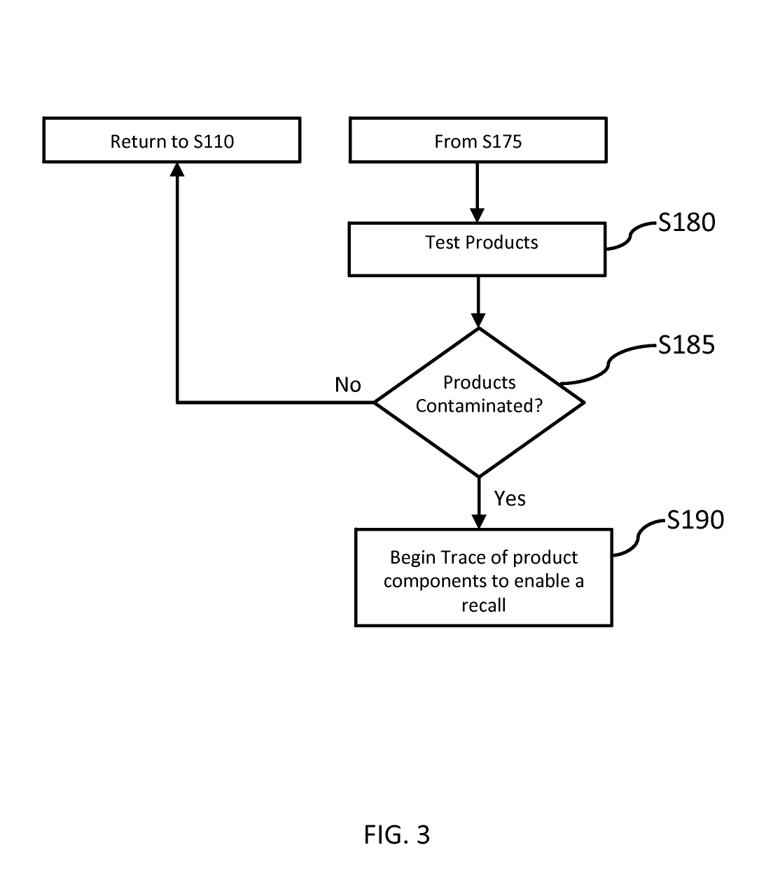

FIGS. 1-3 illustrate first, second and third portions of a first example contaminated product discovery method, in accordance with one embodiment of the invention. Generally, to establish a need for implementing the method for discovering a contaminated food product, a consumer or patient is diagnosed by a healthcare provider as having a particular health condition or illness, which may potentially have been caused by a contaminated product, according to a step S110. Such contaminants may include but are not limited to bacteria, mycotoxins, viruses, parasites or natural toxins. In some circumstances, a diagnosis may not be complete but a temporary diagnosis may be issued in accordance with patient signs or symptoms before laboratory test results of the patient have been released. Any diagnosis or potential diagnosis may be recorded in the healthcare file of the patient.

With the patient diagnosed, the first personal identifier associated with the patient's healthcare file is used to retrieve or look up one or more second personal identifiers of the patient from a merchant bank database in accordance with a step S115. The second personal identifier may be a payment means identifier, usable to associate the diagnosed patient with potentially contaminated products the patient may have purchased.

A merchant bank database 720 associates second personal identifiers with merchant identifiers of one or more merchants who processed transactions involving the associated second personal identifiers. With second personal identifiers retrieved using the patient identifier, a list of merchant identifiers associated with the second personal identifiers in the merchant bank database may also be established according to a step S120.

An optional step S120A (FIG. 1), may be performed, in some embodiments, after retrieval of a list of merchant identifiers according to step S120. Merchant identifiers associated with the second personal identifiers in the merchant bank database are limited to a list of merchant identifiers which each include a potential vulnerability identifier. A potential vulnerability identifier may include but is not limited to a standard industrial application code (SIC) in which a component of each merchant identifier represents the industry the merchant represented by the merchant identifier operates in.

Thus, in some embodiments, merchant identifiers with SIC codes representing industries less likely to process transactions involving products vulnerable to the contamination believed to have caused the illness or health condition are not retrieved or are retrieved and subsequently discarded. Elimination of a number of merchant identifiers from the list of all merchant identifiers associated with the second personal identifier may significantly decrease processing time for a method of discovering contaminated products.

For example, if the illness or condition is believed to have been caused by Escherichia coli, and the SIC code of a merchant identifier indicates the merchant operates in the automotive parts industry, that merchant identifier may not be retrieved or may be retrieved and discarded. Alternatively, if the SIC code of the merchant identifier indicates the merchant operates in the grocery industry or the dining industry, the merchant identifier will be retrieved and will not be discarded.

With a list of merchant identifiers established, transactions processed by merchants having the established merchant identifiers are identified and, if necessary, transaction identifiers are retrieved. In some embodiments, the merchant bank database may include a direct association between the second personal identifier and transaction identifiers. In other embodiments, merchant transaction databases associated with the merchant identifiers are searched and transaction identifiers are retrieved. Thus, according to a step S125, a list of transaction identifiers associated with the second personal identifiers may be retrieved.

Since transaction files frequently include time and date stamps, in some embodiments, retrieving a list of transaction identifiers identifying transactions associated with the second personal identifier additionally includes retrieving a list of transaction identifiers associated with transactions taking place only during a pre-determined time interval in accordance with a step S125A (FIG. 1). If no transactions take place during the pre-defined interval, an inconclusive message may be issued and the method will conclude and subsequently resume when a new patient is diagnosed in accordance with a step S110, as discussed above.

According to a step S130, during a product discovery method, product identifiers are retrieved from recorded transactions that were processed by the merchant using a payment means identified by the second personal identifier. Each transaction identified in the transaction list is associated with one or more products purchased when the transaction was processed by the merchant using the payment means.

Purchased products are represented or identified by product identifiers capable of representation in a serialized form and configured for provision on or in a product or product packaging. Product identifiers are configured for recognition, capture, recording or all of these by a scanner or reader. For example, during transactions at a merchant point of sale or point of service, a scanner reads a product tag, such as a 1- or 2-dimensional bar code, and records product identifiers into a transaction list in association with the second consumer identifiers used for payment or, in an alternative, a radio frequency identifier (RFID) reader reads an RFID tag provided with the product or product packaging.

In some embodiments, a product identifier may be keyed in by a party associated with the merchant such as a merchant employee. For example, in a dining facility, a server may key in, select or otherwise record product identifiers associated with particular foods.

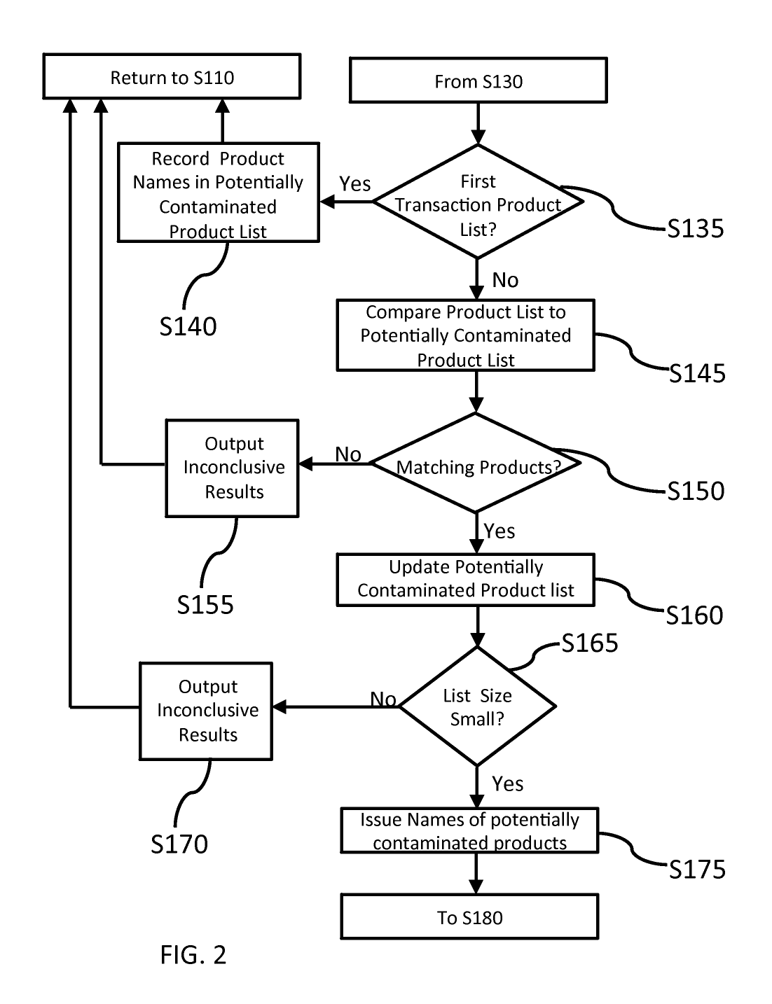

According to a step S135 (FIG. 2), the system 1000 (FIG. 11) determines whether the list of product identifiers is the first to be retrieved or whether a potentially contaminated product list has been initialized with one product identifier list or combined multiple product identifier lists.

If the list of product identifiers is the first to be retrieved and no potentially contaminated product list has been initialized, the list of product identifiers associated with the payment means identifiers are recorded to the potentially contaminated product list in accordance with a step S140. After initialization of the potentially contaminated product list, potentially contaminated products may be tested or the method may conclude and subsequently resume when other patients are diagnosed with the health condition.

If the list of product identifiers is not the first to be retrieved for the illness diagnosed and a potentially contaminated product list has been initialized, the list of product identifiers is compared to the potentially contaminated product list in accordance with a step S145.

According to a step S150, it is determined whether any product identifiers match product identifiers in the potentially contaminated product list. If, during the comparison between the product identifier list and the potentially contaminated product list, no product identifiers are found to be common to both lists, it will not be possible to reduce the number of possibly contaminated products. As such, according to a step S155 a message indicating inconclusive results may be issued if no product identifiers are common to both lists and the method will resume when one or more additional patients are diagnosed with the health condition.

However, if at least one product identifier matches, the potentially contaminated product list is updated with product identifiers common to both the list of product identifiers and the potential contaminated product list in accordance with a step S160.

With an updated potentially contaminated product list, the number of product identifiers in the updated potentially contaminated product list is compared with or measured against a threshold according to a step S165. The threshold may be pre-established before beginning the product discovery method and may be any number representing a quantity of products which may be easily directly tested in a laboratory setting, as appropriate. For example, testing 1000 products may not be feasible while testing 10 or 100 products may be. In some embodiments, the threshold may be updated during the contaminated product discovery method in accordance with other relevant information.

If the number of product identifiers in the updated potentially contaminated product list is above the threshold a message indicating inconclusive results is issued in accordance with a step S170, the process concludes and will resume when one or more additional patients are diagnosed with the illness (S110).

In some circumstances, it may be necessary to repeat the retrieving of steps S115, S120, S125, the extracting of step S130, the comparing of step S145, the updating of step S160 and the comparing of step S165 several times for several patients or consumers diagnosed with the health condition before the number of product identifiers in the potentially contaminated product list is smaller than the threshold and sufficiently small for testing for the presence of a contaminant known to cause the patients' health condition.

If the number of product identifiers in the potentially contaminated product list is below the threshold, a message is issued recommending product testing for product identifiers in the updated potentially contaminated product list in accordance with a step S175. The product testing recommended message can include the relatively small potentially contaminated product list containing the product identifiers representative of potentially contaminated products.

Any products identified in the issued message may now be tested directly by chemical means, biological means, radiological means, etc, in a laboratory setting, as appropriate, according to steps S180 and S185. It should be noted that this testing in accordance with steps S180 and S185 may be partially or wholly implemented by computer or may be implemented entirely without a computer.

If one or more of the products are contaminated, a track and trace method in accordance with a step S190 may be initiated in order to issue a recall, determine if the product has contaminated sub-components or both of these. With advantageous serialized product identifiers, only the products determined to be part of the same series or batch as the product determined to be contaminated during direct testing are recalled. Thus, the entire product line within merchant inventory need not be recalled.

Since consumers or patients often consume products they did not purchase directly, in some instances a search for potentially contaminated products may not be limited to those purchased with the payment means of the diagnosed patient.

In some embodiments, the first patient may be associated with one or more related consumers within the healthcare database file of the first patient. For example, the file of the first patient may contain patient information such as but not limited to residential address, personal identifiers of housemates, and personal identifiers of genetically related or blood-related consumers.

In some embodiments, the residential address of the first patient health file may be used to determine the identities of other parties residing at that address and establish housemate personal identifiers and blood-related personal identifiers. In some embodiments, these identifiers may be provided at the time of establishing the healthcare file or may be updated at various times including but not limited to the time of diagnosis of the health condition or illness.

Again, for privacy protection, access to information regarding the first patient or any of the related consumers may only be provided to parties with valid authorizing credentials in accordance with local, state and federal rules, regulations, laws and policies. In some embodiments, the related consumers may be given one or more opportunities to approve access to information associated with themselves. In some embodiments, related consumers may withhold information associated with themselves.

Once obtained or otherwise provided, the first personal identifiers of related consumers may be used in accordance with any of the methods disclosed herein. For example, second personal identifiers of consumers related to the diagnosed patient through the healthcare database are looked up within a merchant bank database (S115); a list of merchant identifiers associated with the second personal identifiers of the related consumers are retrieved from the merchant bank database (S120); a list of transactions performed with the payment means of the related consumers and processed by the merchants represented by the merchant identifiers is retrieved (S125); and a list of product identifiers associated with the second personal identifiers of the related consumers are extracted from a merchant transaction database associated with the merchant identifiers (S130).

Then, the list of product identifiers are compared to a potentially contaminated product list (S145); the potentially contaminated product list is updated with product identifiers common to both the list of product identifiers and the potential contaminated product list (S160); the number of product identifiers in the updated potentially contaminated product list is measured against a threshold (S165); a message indicating inconclusive results is issued if the number is above the threshold (S170); and a message indicating product testing is recommended is issued for product identifiers in the updated potentially contaminated product list if the number is below the threshold (S175).

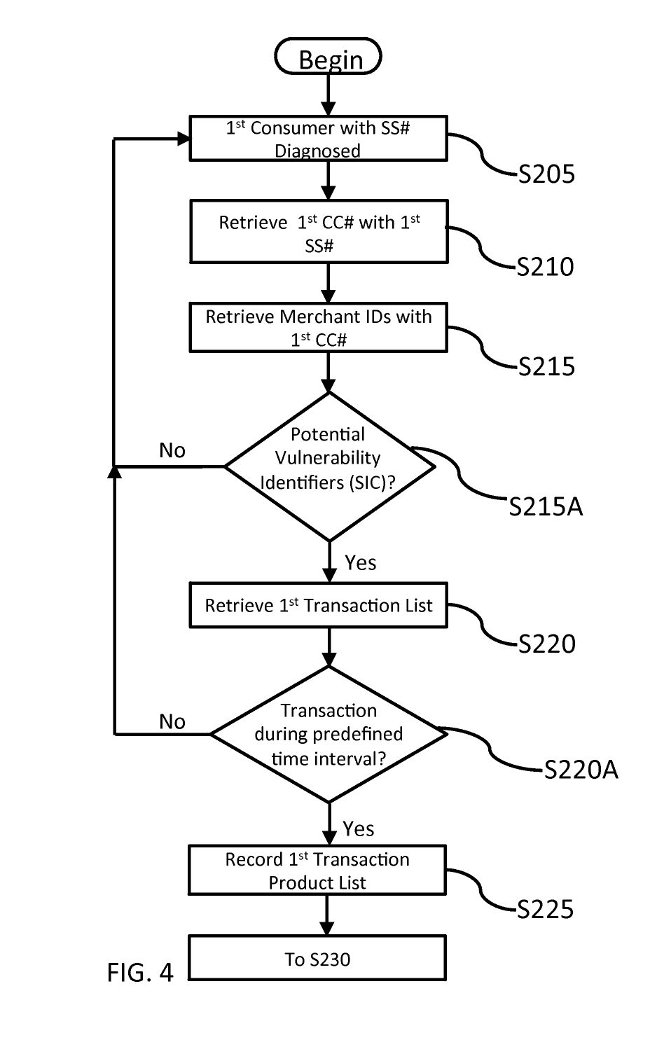

As shown in FIGS. 4-6, a computer-implemented method for discovering a contaminated product, may not require establishing a potentially contaminated product list with an initialization step.

A first consumer or patient identified by a first personal identifier such as a social security number is diagnosed with a health condition or illness in accordance with a step S205 (FIG. 4). It is noted that this step may be but need not be performed with a computer or with the assistance of a computer.

According to a step S210, second personal identifiers such as credit card numbers associated with the first personal identifier of the first patient are looked up within a merchant bank database. With the second personal identifiers retrieved, a list of merchant identifiers associated with the second personal identifiers in the merchant bank database may also be retrieved according to a step S215.

As with the example method described with reference to FIGS. 1-3, merchant identifiers associated with the second personal identifiers in the merchant bank database may optionally be limited to a list of merchant identifiers including a potential vulnerability identifier (S215A, FIG. 4). Thus, in some embodiments, merchant identifiers lacking a potential vulnerability identifier are not retrieved or are retrieved and subsequently discarded. Elimination of a number of merchant identifiers from the list of all merchant identifiers associated with the second personal identifiers of the first patient may significantly decrease processing time for the method of discovering contaminated products referenced by FIGS. 4-7.

According to a step S220, a first transaction list is retrieved either from a merchant transaction database associated with the merchant identifiers or from the merchant bank database. As with the example method described with reference to FIGS. 1-3, retrieving a list of transaction identifiers identifying transactions associated with the first patient first personal identifier may additionally include the optional step of retrieving a list of transaction identifiers limited to a pre-determined time interval (S220A, FIG. 4). If no transactions take place during the pre-defined interval, a message indicating inconclusive results may be issued and the method may conclude.

In the transaction list, each transaction identified is associated with one or more products purchased when the transaction was processed by the merchant using payment means. According to a step S225, a first list of product identifiers is retrieved from transactions processed and recorded by the merchant using the second personal identifiers of the first patient. As mentioned above, product identifiers may be captured by a reader or may be keyed-in or selected by a merchant employee or other party associated with the merchant.

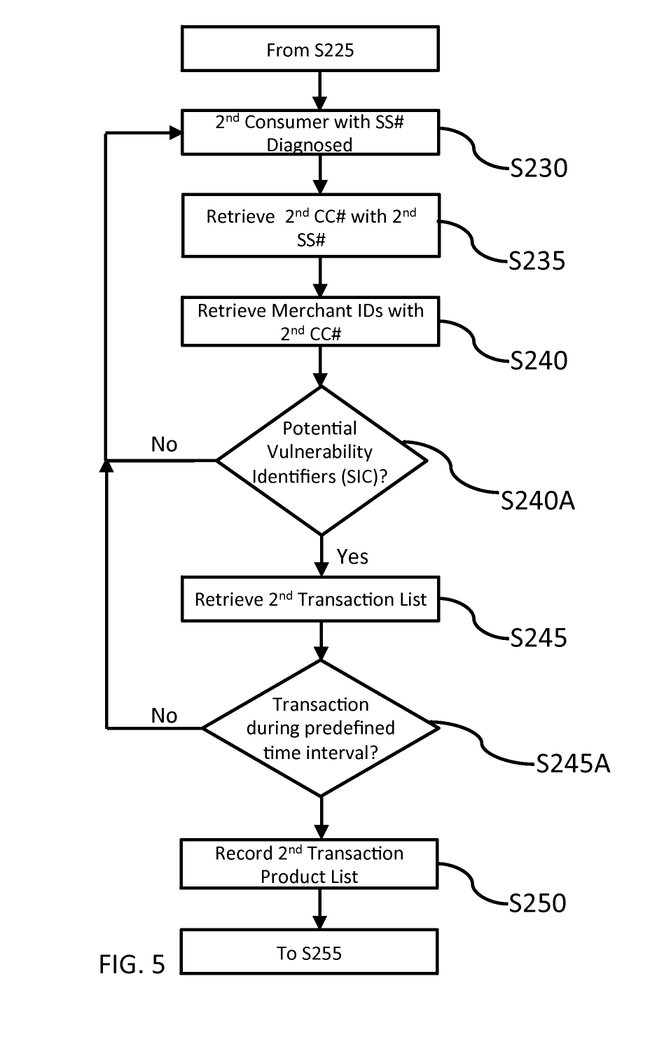

When a second patient identified, in a healthcare database, by a second patient first personal identifier such as a social security number, is diagnosed with the health condition in accordance with a step S230 (FIG. 5), according to a step S235, second patient second personal identifiers such as consumer credit card numbers associated with the second patient first personal identifier are looked up within a merchant bank database.

A list of merchant identifiers are retrieved from the merchant bank database using the obtained second patient second personal identifiers according to a step S240. As above, merchant identifiers associated with the second patient second personal identifier in the merchant bank database may optionally be limited to a list of merchant identifiers including a potential vulnerability identifier (S240A, FIG. 5).

In accordance with a step S245, a second transaction list associated with the merchant identifiers in the merchant transaction database is retrieved. As above, retrieving a list of transaction identifiers identifying transactions associated with the second patient second personal identifiers may additionally include the optional step of retrieving a list of transaction identifiers limited to a pre-determined time interval (S245A, FIG. 5).

Using the merchant identifiers and transaction list, a second list of product identifiers associated with the second patient second personal identifiers are extracted from a merchant transaction database associated with the merchant identifiers in accordance with a step S250.

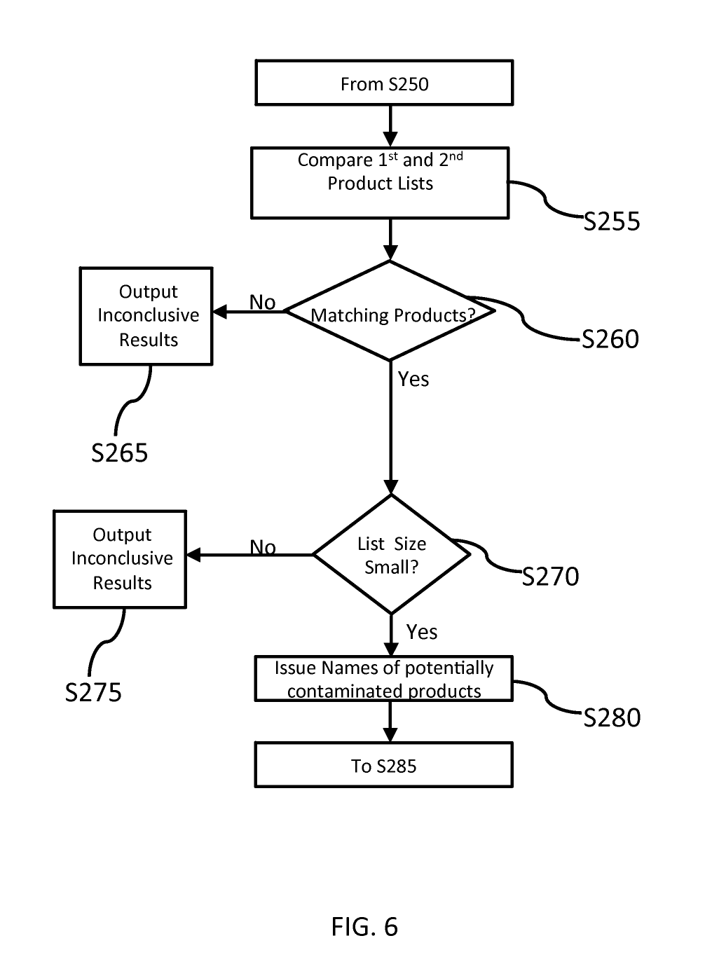

According to a step S255 (FIG. 6), the first list of product identifiers is compared with the second list of product identifiers and it is determined whether any product identifiers match in accordance with a step S260. When no products match, a message indicating inconclusive results is output according to a step S265. However, when one or more products match, the number of product identifiers common to both lists is measured against or compared with a threshold in accordance with a step S270.

When the number is above the threshold a message indicating inconclusive results is issued according to a step S275 and when the number is below the threshold, a message indicating product testing is recommended is issued for the products associated with the product identifiers common to both the first list of product identifiers and the second list of product identifiers according to a step S280. The product testing recommended message can include the relatively small list containing the product identifiers representative of potentially contaminated products.

As with the method described in reference to FIGS. 1-3, any products identified in the issued message may now be tested directly by chemical means, biological means, radiological means, etc, in a laboratory setting, as appropriate according to steps S285 and S290. Again, this testing in accordance with steps S285 and S290 may be partially or wholly implemented by computer or may be implemented entirely without a computer.

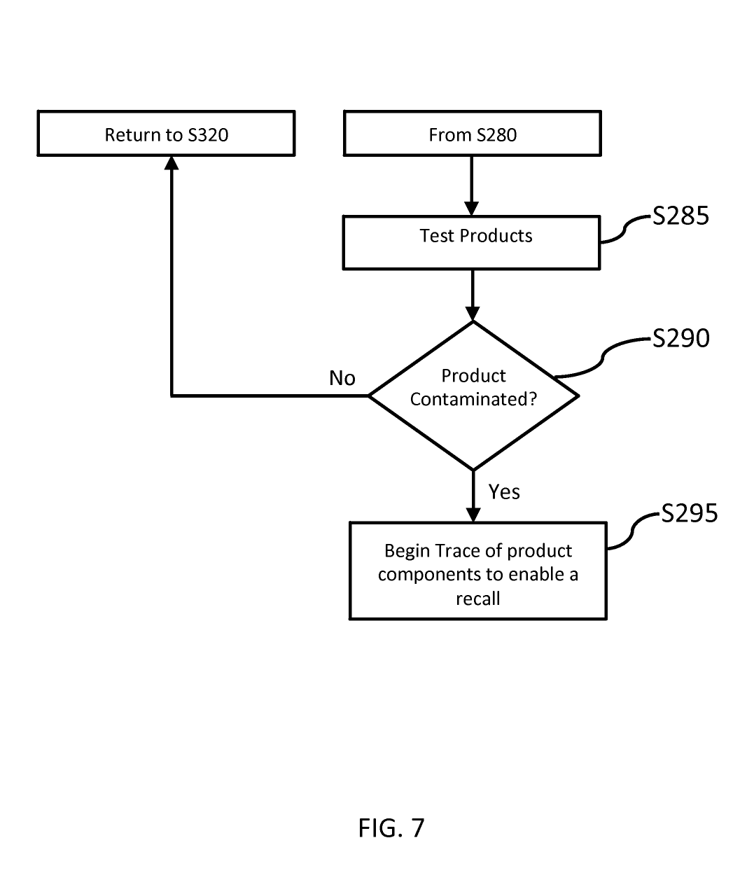

If one or more of the products are contaminated, a track and trace method may be initiated in accordance with a step S295 (FIG. 7).

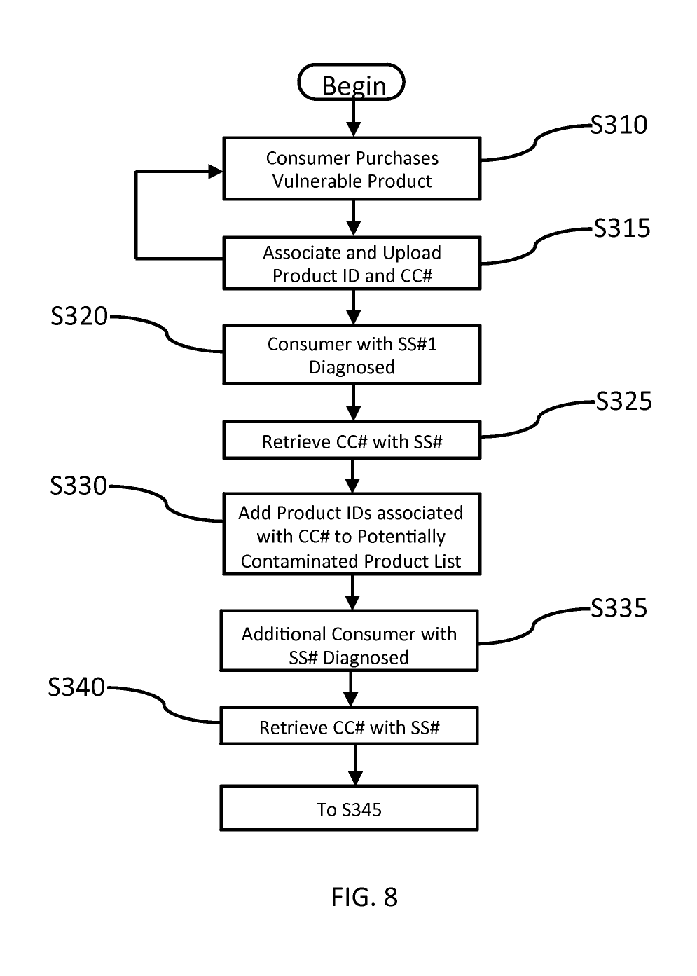

Referring to FIGS. 8-10, in some embodiments, a computer-implemented method may facilitate or expedite contaminated product discovery by reducing the number of product identifiers being compared among transactions.

When a consumer engages in a transaction involving a purchase of a contamination-vulnerable product according to a step S310 (FIG. 8), the product identifier of the contamination-vulnerable product is associated with a second personal identifier of the consumer such as a payment means identifier which is, in turn, associated with the transaction within a database of purchased vulnerable products in accordance with a step S315. The database of purchased vulnerable products may reside at any of a variety of locations or may be distributed over a variety of locations.

In steps S310 and S315, only product identifiers of contamination-vulnerable products and the corresponding second personal identifiers are associated within the database of purchased vulnerable products. Steps S310 and S315 may be executed indefinitely and in real time to provide a robust and up-to-date list of associations between one or more second personal identifiers and one or more product identifiers representing contamination-vulnerable products. The criteria for identifying a product as contamination-vulnerable may be pre-established or may be updated continuously. In some embodiments, such contamination-vulnerable products may be distinguished from other products by a sub-component of their product identifiers.

In order to prevent excessive growth of any database containing the list of purchased contamination-vulnerable product identifiers, product identifiers and corresponding second personal identifiers may be deleted from the database after a pre-established time interval. This interval, which may be established according to a user's desires or according to information relevant to health conditions or illnesses with which patients may be diagnosed.

When a first patient is diagnosed with a health condition potentially caused by a contamination-vulnerable product in accordance with a step S320, a first personal identifier of the first patient is retrieved from a patient healthcare database, and matched with one or more of the plurality of second personal identifiers stored in association with the product identifiers according to a step S325. Since the product identifiers and second personal identifiers are already stored in association, it may not be necessary to retrieve merchant identifiers and merchant transaction lists with the second personal identifiers.

Product identifiers associated with the second personal identifiers of the first diagnosed patient may be recorded to a potentially contaminated products database according to a step S330. If no additional patients are diagnosed with the health condition, it may not be possible to reduce the potentially contaminated products list to a size feasible for direct, individual testing.

In a step S335, an additional patient or consumer is diagnosed with the illness potentially caused by a contamination-vulnerable product. According to a step S340, a first personal identifier of the additional consumer is retrieved, from a patient health database, and matched with second personal identifiers of the additional consumer.

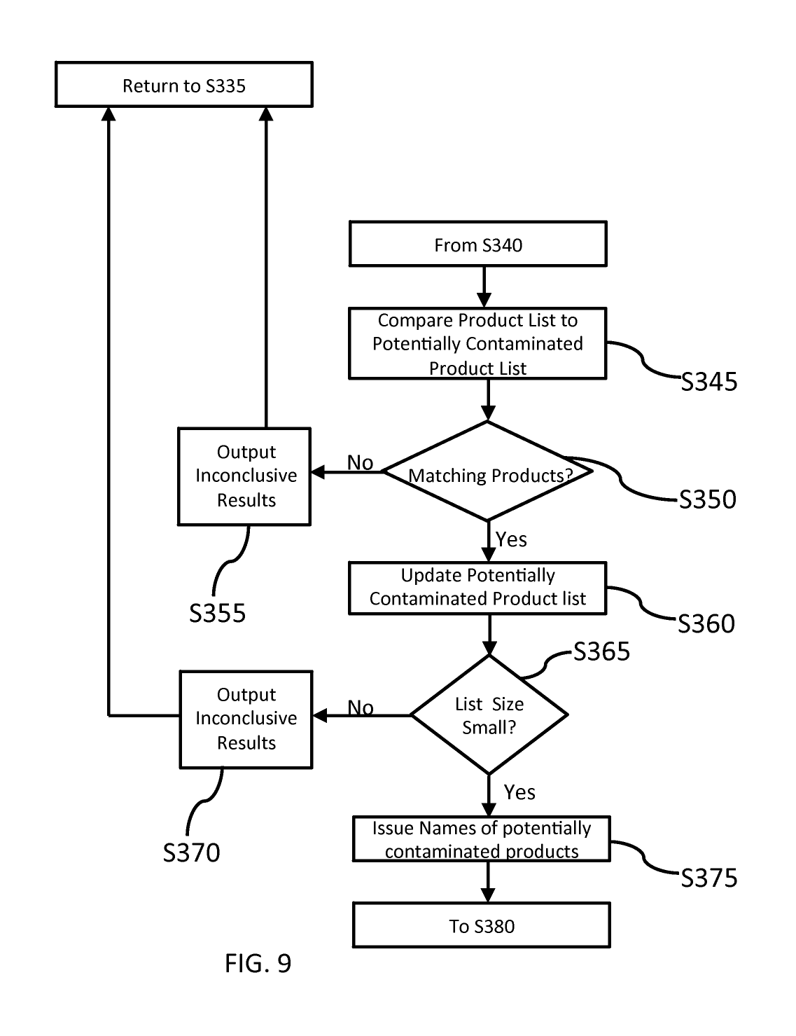

According to steps S345, S350 and S360 (FIG. 9), product identifiers associated with the second personal identifiers of the additional patient are retrieved and the potentially contaminated products database is updated with the product identifiers associated with both the second personal identifiers of the first diagnosed patient and the second personal identifiers of the additional patient.

If no product identifiers are commonly associated with both the second personal identifiers of the first patient and the second personal identifiers of the additional patient, a message indicating inconclusive results is output according to a step S355 and the process will begin again when an additional consumer is diagnosed with the health condition in a step S335.

When one or more product identifiers are commonly associated with both the second personal identifiers of the first patient and the second personal identifiers of the additional patient, according to a step S365, the number of common product identifiers in the updated potentially contaminated product list is measured against or compared with a threshold.

If the number is above the threshold, a message indicating inconclusive results is issued in accordance with a step S370 and the process will resume when an additional consumer is diagnosed with the health condition in a step S335.

If the number is below the threshold, according to a step S375, a message indicating product testing is recommended is issued for the products associated with the product identifiers in the updated potentially contaminated product list. The product testing recommended message can include the relatively small potentially contaminated product list including the product identifiers representative of potentially contaminated products.

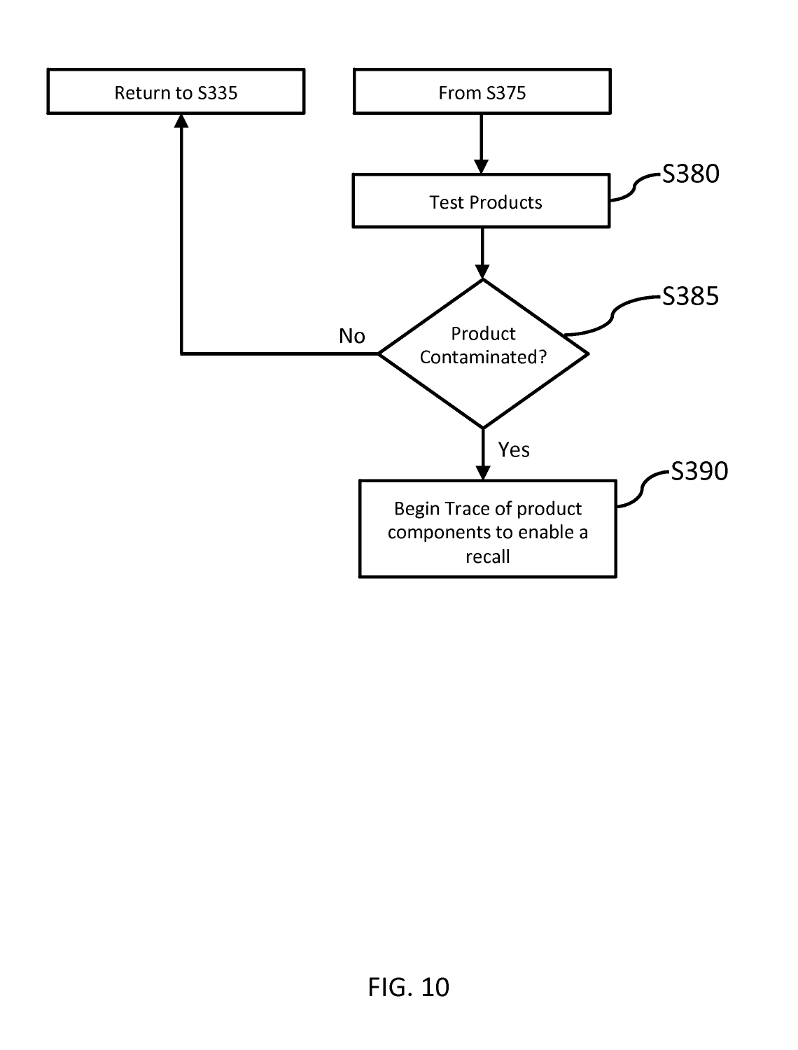

Any products identified in the issued message may now be tested directly by chemical, biological, radiological, etc means in a laboratory setting, as appropriate, according to steps S380 and 385 (FIG. 10). Again, this testing in accordance with steps S380 and S385 may be partially or wholly implemented by computer or may be implemented entirely without a computer.

If one or more of the products are contaminated, a track and trace method in accordance with a step S390 may be initiated in order to issue a recall, determine if the product has contaminated sub-components or both of these.

A system 1000 (FIG. 11) for discovering a contaminated product includes a number of complimentary components.

A consumer or patient healthcare database 710 contains a plurality of patient health record files or objects each uniquely identifiable with a first personal identifier and, in some embodiments, may include one or more first or second personal identifiers of related consumers.

A first search engine, information retrieval engine or querying module 610 is configured to retrieve, from a merchant bank database, one or more second personal identifiers associated with the first personal identifier. In embodiments wherein the healthcare database includes information about consumers related to the diagnosed patient, first search engine 610 is further configured to retrieve, from the merchant bank database, one or more second personal identifiers associated with one or more first personal identifiers of related consumers.

A second search engine, information retrieval engine or querying module 620 is configured to retrieve, from the merchant bank database 720, a list of one or more merchant identifiers associated with the one or more second personal identifiers. In some embodiments, second search engine 620 is configured to retrieve, from the merchant bank database, a list of only those merchant identifiers including a potential vulnerability identifier such as an SIC code.

A third search engine, information retrieval engine or querying module 630 is configured to extract, from a merchant transaction database 740 associated with the merchant identifiers, a list of product identifiers associated with the one or more second personal identifiers. Product identifiers of products sold during transactions with the merchant may be captured and associated with particular transactions within the transaction database 740 using, for example, an RFID reader 745. In some embodiments, the third search engine is configured to retrieve a list of transactions associated with the merchant identifiers in addition to retrieving the merchant identifiers, as appropriate, according to the storage location of transaction lists. In some embodiments, the third search engine is further configured to extract, from the merchant transaction database associated with the merchant identifiers, a list of product identifiers associated with the one or more second personal identifiers and a pre-determined purchase date range.

One or more of the search engines 610, 620 and 630 are configured to retrieve data from databases 710, 720, 730 and 740 over a communications network 810. Communications network 810 may be of any of a variety of network types including but not limited to a computing network or a mobile network.

A first comparison engine 660 is configured to match, product identifiers from the list of product identifiers to potentially contaminated product identifiers in a potentially contaminated product list 670.

A potentially contaminated product list manager 640 is configured to update or overwrite the potentially contaminated product list with product identifiers common to both the list of product identifiers and the potentially contaminated product list.

A second comparison engine or threshold tester 650 is configured to compare the number of product identifiers in the updated potentially contaminated product list 670 against a threshold.

An output 680 is configured to issue an “inconclusive” message if no product identifiers are common to both lists, issue an “inconclusive” message if the number is above the threshold and to issue a “product testing recommended” message for product identifiers in the updated potentially contaminated product list if the number is below the threshold. Messages issued from output 680 may include any of a variety of information beyond the indication that an iteration of a product contamination discovery has not resulted in a conclusion or a hypothesis verification. Furthermore, messages may be issued in any of a variety of forms including hardcopy output such as from a printer, visual output such as to a display, audible output such as through audio speakers or tactile output such as through a vibrating peripheral or other appliance.

A track and trace engine 690 may be provided in a configuration enabling tracing one or more product identifiers in the potentially contaminated product list through a manufacturing process, a distribution process or both to determine product components.

A person skilled in the art should understand that the embodiments of the present application, in addition to being implemented as methods or systems, may also be implemented as computer software or program products. Therefore, the described embodiments can take the form of entirely software embodiments (including firmware, resident software, micro-code, etc) in addition to entirely hardware embodiments, or embodiments combining hardware and software aspects.

Each process and/or block in the flow charts and/or block diagrams, and combinations of processes and/or blocks in the flow charts and/or block diagrams, can be achieved through computer program commands written in any of a variety of suitable programming languages including, but not limited to procedural languages such as, for example, C, Fortran or BASIC, and object oriented programming languages such as, for example, C++, Java or Python. These computer commands can be provided to a general-purpose computer, a specialized computer, an embedded processor, or the processor of other programmable data equipment so to be rendered as a machine. As a result, the commands executed through the computer or processor or other programmable data equipment render a device that is used to realize the functions designated by one or more processes in a flow chart and/or one or more blocks in a block diagram.

Computer program commands can be provided stored on specially-operating computer-readable storage devices that can guide computers or other programmable data equipment. Computer program commands can be implemented on one or more computer-operable storage media (including but not limited to magnetic disk storage devices, CD-ROMs, optical storage devices and other tangible, non-transient media) containing computer program codes. As a result, the commands stored on these computer-readable devices render products that include command devices realizing the functions designated in one or more processes in a flow chart and/or one or more blocks in a block diagram.

The computer program commands can also be loaded onto a computer or other programmable data equipment, with the result that a series of operating steps are executed on a computer or other programmable equipment so as to give rise to computer processing. In this way, the commands executed on a computer or other programmable equipment provide steps for realizing the functions designated by one or more processes in a flow chart and/or one or more blocks in a block diagram.

While the disclosure has been presented with respect to certain specific embodiments, it will be appreciated that many modifications and changes may be made by those skilled in the art without departing from the spirit and scope of the invention. It is intended, therefore, by the appended claims to cover all such modifications and changes as fall within the true spirit and scope of the invention.

What is claimed is:

1. A computer-implemented method for discovering a contaminated product, comprising:
in response to diagnosing a health condition in a first patient identified by a first personal identifier in a healthcare database, looking up, within a merchant bank database, second personal identifiers associated with the first personal identifier;
retrieving a list of merchant identifiers associated with the second personal identifiers in the merchant bank database;
retrieving a list of transaction identifiers associated with the second personal identifiers in a merchant transaction database associated with the merchant identifiers;
extracting, from the merchant transaction database, a list of product identifiers associated with the second personal identifiers;
comparing, to a potentially contaminated product list, the list of product identifiers;
updating the potentially contaminated product list with product identifiers common to both the list of product identifiers and the potential contaminated product list;
comparing the number of product identifiers in the updated potentially contaminated product list with a threshold;
issuing an inconclusive results message in response to determining the number is above the threshold; and
issuing a product testing recommended message for product identifiers in the updated potentially contaminated product list in response to determining the number is below the threshold.

2. The method as set forth in claim 2, wherein comparing further comprises, constructing the potentially contaminated product list by:
in response to diagnosing a health condition in an originating consumer identified by an originating first personal identifier in the healthcare database, looking up, within a merchant bank database, originating second personal identifiers associated with the originating first personal identifier;
extracting, from the transactions associated with the originating second personal identifier, a list of product identifiers associated with products purchased during the transactions associated with the originating second personal identifier; and
storing, in the potential contaminated product list, the list of product identifiers associated with products purchased during the transactions associated with the originating second personal identifier.

3. The method as set forth in claim 1, further comprising:
associating one or more related personal identifiers with the first personal identifier of the first patient;
within a merchant bank database, looking up related second personal identifiers associated with the related first personal identifier;
retrieving a list of merchant identifiers associated with the related second personal identifiers in the merchant bank database;
extracting, from a merchant transaction database associated with the merchant identifiers, a list of product identifiers associated with the related second personal identifiers;
comparing, to a potentially contaminated product list, the list of product identifiers;
updating the potentially contaminated product list with product identifiers common to both the list of product identifiers and the potential contaminated product list;
comparing the number of product identifiers in the updated potentially contaminated product list with a threshold;
issuing an inconclusive results message in response to determining the number is above the threshold; and
issuing a product testing recommended message for product identifiers in the updated potentially contaminated product list in response to determining the number is below the threshold.

4. The method as set forth in claim 1, wherein retrieving a list of merchant identifiers associated with the second personal identifiers in the merchant bank database further comprises retrieving a list of merchant identifiers including a potential vulnerability identifier.

5. The method as set forth in claim 1, wherein the first personal identifier comprises a government-issued identifier.

6. The method as set forth in claim 5, wherein the government-issued identifier comprises a social security number.

7. The method as set forth in claim 1, wherein the second personal identifier comprises a payment means identifier.

8. The method as set forth in claim 7, wherein the payment means identifier comprises a credit card number.

9. The method as set forth in claim 7, wherein the payment means identifier comprises a debit card number.

10. The method as set forth in claim 1, further comprising repeating the retrieving, extracting, comparing, updating and comparing a plurality of times for a plurality of patients determined to have the health condition.

11. The method as set forth in claim 1, further comprising issuing an inconclusive message in response to determining no product identifiers are common to both the product list and the potentially contaminated product list.

12. The method as set forth in claim 1, further wherein retrieving the list of transaction identifiers identifying transactions associated with the second personal identifiers further comprises retrieving a list of transaction identifiers associated with transactions taking place during a pre-determined time interval.

13. The method as set forth in claim 1, further comprising tracing one or more product identifiers in the potentially contaminated product list through a manufacturing process, a distribution process or both to determine product components.

14. The method as set forth in claim 13, further comprising recalling products containing the product components.

15. A computer-implemented method for discovering a contaminated product, comprising:
in response to diagnosing a health condition in a first patient identified by a first personal identifier in a healthcare database, looking up, within a merchant bank database, second personal identifiers associated with the first personal identifier;
retrieving a list of merchant identifiers associated with the second personal identifiers in the merchant bank database;
extracting, from a merchant transaction database associated with the merchant identifiers, a first list of product identifiers associated with the second personal identifiers;
in response to diagnosing a health condition in a second patient identified by a second patient first personal identifier in the healthcare database, looking up, within a merchant bank database, second patient second personal identifiers associated with the second patient second personal identifiers;
retrieving a list of merchant identifiers associated with the second patient second personal identifiers in the merchant bank database;
extracting, from a merchant transaction database associated with the merchant identifiers, a second list of product identifiers associated with the second patient second personal identifiers;
recording product identifiers common to both the first list of product identifiers and the second list of product identifiers;
comparing the number of product identifiers recorded with a threshold;
issuing an inconclusive results message in response to determining the number is above the threshold; and
issuing a product testing recommended message for the products associated with the product identifiers common to both the first list of product identifiers and the second list of product identifiers in response to determining the number is below the threshold.

16. A computer-implemented method, comprising:
during consumer transactions of a contamination-vulnerable product, associating a plurality of product identifiers with a plurality of consumer identifiers within a database of purchased contamination-vulnerable products;
in response to determining that a first patient has a health condition potentially caused by a contamination-vulnerable product, retrieving, from a patient health database, a patient identifier of the first patient;
matching the patient identifier to a first one of the plurality of consumer identifiers;
storing product identifiers associated with the first of the plurality of consumer identifiers in a potentially contaminated products database;
in response to determining that an additional patient has the illness potentially caused by a contamination-vulnerable product, retrieving, from the patient health database, a patient identifier of the additional consumer;
matching the patient identifier of the additional consumer to a second of the plurality of consumer identifiers;
retrieving product identifiers associated with the second of the plurality of consumer identifiers;
updating the potentially contaminated products database with product identifiers associated with both the first and the second of the plurality of consumer identifiers;
comparing the number of product identifiers in the updated potentially contaminated product list with a threshold;
issuing an inconclusive results message in response to determining the number is above the threshold; and
issuing a product testing recommended message for the products associated with the product identifiers in the updated potential contaminated product list in response to determining the number is below the threshold.

17. A system for discovering a contaminated product, comprising:
a consumer health database containing a plurality of consumer health record objects each including a first personal identifier;
a first search engine configured to retrieve, from a merchant bank database, one or more second personal identifiers associated with the first personal identifier;
a second search engine configured to retrieve, from the merchant bank database, a list of one or more merchant identifiers associated with the one or more second personal identifiers;
a third search engine configured to extract, from a merchant transaction database associated with the merchant identifiers, a list of product identifiers associated with the one or more second personal identifiers;
a first comparison engine configured to match, product identifiers from the list of product identifiers to potentially contaminated product identifiers in a potentially contaminated product list;
a potentially contaminated product list update engine configured to update the potentially contaminated product list with product identifiers common to both the list of product identifiers and the potentially contaminated product list;
a second comparison engine configured to compare the number of product identifiers in the updated potentially contaminated product list with a threshold; and
an output engine configured to issue an inconclusive results message in response to determining the number is above the threshold and to issue a product testing recommended message for product identifiers in the updated potentially contaminated product list in response to determining the number is below the threshold.

18. The system as set forth in claim 17, wherein:
at least one of the plurality of consumer health record objects further includes one or more related first personal identifiers; and
the first search engine is further configured to retrieve, from the merchant bank database, one or more second personal identifiers associated with the one or more related first personal identifiers.

19. The system as set forth in claim 17, wherein the second search engine is further configured to retrieve, from the merchant bank database, a list of one or more merchant identifiers associated with the one or more second personal identifiers and including a potential vulnerability identifier.

20. The system as set forth in claim 17, wherein the first search engine is configured to retrieve, from a merchant bank database, one or more credit card numbers associated with first personal identifier.

21. The system as set forth in claim 17, wherein the first search engine is configured to retrieve, from a merchant bank database, one or more debit card numbers associated with the first personal identifier.

22. The system as set forth in claim 17, wherein the output is further configured to issue an inconclusive results message in response to a determination that no product identifiers are common to both the product list and the potentially contaminated product list.

23. The system as set forth in claim 17, wherein the third search engine is further configured to extract, from the merchant transaction database associated with the merchant identifiers, a list of product identifiers associated with the one or more second personal identifiers and a pre-determined purchase date range.

24. The system as set forth in claim 17, further comprising a track and trace engine configured to trace one or more product identifiers in the potentially contaminated product list through a manufacturing process, a distribution process or both to determine product components.

25. A computer program product, stored on a non-transitory machine-readable medium, for discovering a contaminated product, comprising instructions operable to cause a computer to:
retrieve, from a merchant bank database, one or more second personal identifiers associated with a first personal identifier stored in a consumer health database containing a plurality of patient health records;
retrieve, from the merchant bank database, a list of one or more merchant identifiers associated with the one or more second personal identifiers;
extract, from a merchant transaction database associated with the merchant identifiers, a list of product identifiers associated with the one or more second personal identifiers;
match product identifiers from the list of product identifiers to potentially contaminated product identifiers in a potentially contaminated product list;
update the potentially contaminated product list with product identifiers common to both the list of product identifiers and the potentially contaminated product list;
compare the number of product identifiers in the updated potentially contaminated product list against a threshold;
output an inconclusive results message in response to determining the number is above the threshold; and
output a product testing recommended message for product identifiers in the updated potentially contaminated product list in response to determining the number is below the threshold.

26. The computer program product as set forth in claim 25, further comprising instructions operable to cause a computer to retrieve, from the merchant bank database, one or more consumer identifiers associated with one or more related first personal identifiers associated with the first patient identifiers in the first patient health database.

27. The program product as set forth in claim 25, wherein the instructions operable to cause the computer to retrieve, from the merchant bank database, a list of one or more merchant identifiers associated with the one or more consumer identifiers further comprise instructions operable to cause the computer to retrieve, from the merchant bank database, a list of one or more merchant identifiers including a potential vulnerability identifier.

28. The program product as set forth in claim 25, wherein the instructions operable to cause the computer to retrieve, from a merchant bank database, one or more consumer identifiers associated with a first patient identifier stored in a patient health database containing a plurality of patient health records further comprise instructions operable to cause a computer to retrieve, from a merchant bank database, one or more credit card numbers associated with the first patient identifier.

29. The program product as set forth in claim 25, wherein the instructions operable to cause the computer to retrieve, from a merchant bank database, one or more consumer identifiers associated with a first patient identifier stored in a patient health database containing a plurality of patient health records further comprise instructions operable to cause a computer to retrieve, from a merchant bank database, one or more debit card numbers associated with the first patient identifier.

30. The computer program product as set forth in claim 25, further comprising instructions operable to cause a computer to issue an inconclusive results message in response to a determination that no product identifiers are common to both the product list and the potentially contaminated product list.

31. The computer program product as set forth in claim 25, wherein the instructions operable to cause the computer to extract, from a merchant transaction database associated with the merchant identifiers, a list of product identifiers associated with the one or more consumer identifiers further comprise instructions operable to cause the computer to extract, from the merchant transaction database associated with the merchant identifiers, a list of product identifiers associated with a pre-determined range of purchase dates.

32. The computer program product as set forth in claim 25, further comprising instructions operable to cause a computer to trace one or more product identifiers in the potentially contaminated product list through a manufacturing process, a distribution process or both to determine product components.
